(19) United States
(12) Patent Application Publication
(10) Pub. No.: US 2008/0287842 A1
(43) Pub. Date: Nov. 20, 2008

(54) STRESS ROLLER

(76) Inventor: Balynda BENSON-GORELICK, Malibu, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/122,100

(22) Filed: May 16, 2008

Related U.S. Application Data
(60) Provisional application No. 60/924,482, filed on May 16, 2007.

(51) Int. Cl. A61H 7/00

(52) U.S. Cl. 601/134

(57) ABSTRACT

An apparatus, includes a first object, a second object, and a shell enclosing the first and second objects and controlling the movement of the first object and the second object. The first object and the second object are balls within the shell accommodating rolling of the apparatus between first and second surfaces. The balls or other object can include a resilient material and shell includes a resilient material. The shell can include a polychloroprene material. The objects can include two similar strips of rubber forming a hollow spherical shape and covered by canvas. There can also be a resilient hollow space for movement of the first and second object while the first and second objects touch at least an area without being connected. The shell can be stretched at the outer circumferences of the first and second objects and tapering in the space between the first and second objects.

### CROSS-REFERENCE TO RELATED APPLICATIONS

This application claims priority to the provisional U.S. patent application entitled, Stress Roller, filed May 16, 2007, having a Ser. No. 60/924,482, the disclosure of which is hereby incorporated by reference in its entirety.

### BACKGROUND OF THE INVENTION

Currently, a wide variety of stress relieving equipment is used to aid the reduction of certain aches and pains within the body. Certain equipment has been used to relieve stress in certain targeted areas or to exercise targeted muscle groups. People have used for example an inflatable ball on certain parts of the body in order to perform certain exercises or to relieve stress to the back. However, such balls are difficult to target more than a single area of contact and are sometimes cumbersome to carry and use. People have also attempted to place balls within socks, but there is a severe lack of control of the balls within the socks. There is a need to have a device that can target more than a single area on the body of a user that is efficient and easy to use and is capable of being controlled.

### SUMMARY OF THE INVENTION

The present invention provides a technique and apparatus that can target a plurality of areas of the body while being convenient to use.

The present invention also provides a force upon a plurality of surfaces at the same time, while being controlled.

The stress roller includes a first object, a second object, and a shell enclosing the first and second objects and controlling the movement of the first object and the second object. The first object and the second object can be balls within the shell accommodating rolling of the apparatus between first and second surfaces. The balls or other object can include a resilient material and shell includes a resilient material. The shell can include a polychloroprene material. The objects can include two similar strips of rubber forming a hollow spherical shape and covered by canvas. There can also be a resilient hollow space for movement of the first and second object while the first and second objects touch at least an area without being connected. The shell can be stretched at the outer circumferences of the first and second objects and tapering in the space between the first and second objects.

In another aspect of the disclosure, there is a method of manufacture, including forming a first object, forming a second object, and enclosing the first and second objects and accommodating movement of the first object and the second object controlled according to the size and material of the shell and the shape of the first and second objects.

In another aspect of the disclosure, there is a rolling system, comprising a first means for rolling, a second means for rolling, and a means for enclosing completely the first and second means for rolling and accommodating a certain movement of the first object and the second object constrained according to certain predetermined conditions.

The stress roller can be rolled for example around certain areas of the body of the user. For example the stress roller can be rolled between the shoulder blades, where each ball of the stress roller contacts a certain area of the body and accommodates a rolling motion.

There has thus been outlined, rather broadly, certain embodiments of the invention in order that the detailed description thereof herein maybe better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a stress roller according to an embodiment of the invention.

FIG. 2 is a view of the stress roller and a bag to hold the stress roller.

FIG. 3 illustrates the stress roller at the mid-back area.

FIG. 4 illustrates the stress roller at the middle-back area of the user.

FIG. 5 illustrates the stress roller at the neck area of the user.

FIG. 6 illustrates the stress roller around the lower back area.

FIG. 7 illustrates the stress roller around the hip area.

### DETAILED DESCRIPTION OF THE INVENTION

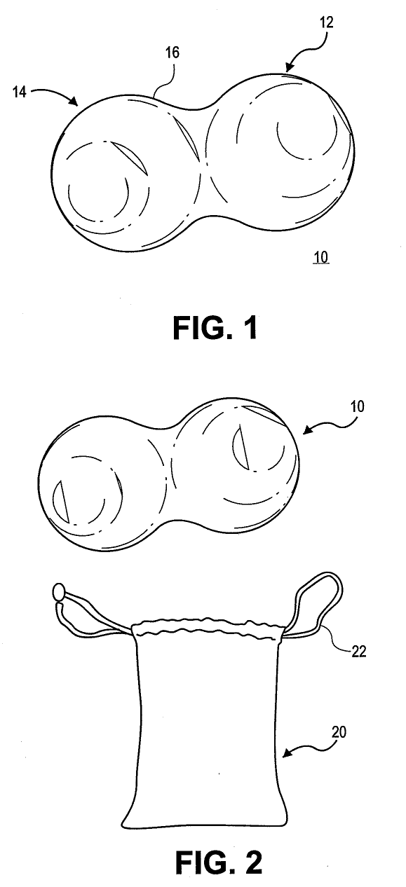

Referring to FIG. 1, one embodiment of the present invention includes a stress ball 10 including a first object 12 and a second object 14 wrapped in a shell 16. The shell can be completely enclosing the first object 12 and second object 14. The shell 16 enclosing the objects 12 and 14 can be made of a material such as NEOPRENE or other polychloroprene type material. The material of the shell 16 can also be synthetic rubber based on polychloroprene or other synthetic or non-synthetic rubber compound. The material for the shell 16 can also be a compound with certain elasticity. The shell 16 enclosing the objects 14 and 16 can provide a certain control and stability for the stress roller 10. The movement of the objects 12 and 14 are contained within the shell 16, while still accommodating a controlled movement of the objects 12 and 14.

The shell 16 can be a flat material stitched or otherwise fastened to form a hollow enclosure for the objects 12 and 14. The shell 16 can also be formed as a continuous hollow enclosure for the objects 12 and 14. The space between the shell can be alternatively filled with an additional material to further control the movement of the objects 12 and 14.

The first object 12 and second object 14 can be balls or spherical shaped objects. The objects 12 and 14 can also be hollow; allowing a greater resilience when forced is applied. The objects 12 and 14 can also provide a resilient force back on the subject upon which the stress roller 10 is applied. The first and second objects 12 and 14 are not limited to a spherical shape, but can also be other shapes. The first and second objects 12 and 14 can be identical or they can different sizes and shapes. Therefore, the stress roller 10 can include two identically sized spherical balls 12 and 14 in a shell 16 made from NEOPRENE or similar substance.

The balls or objects 12 and 14 can be made of a variety of material including material with a resiliency. For example, one or both objects 12 and 14 can be made of rubber or other plastic type material or of an organic type material. The inner core of the objects 12 and 14 can be hollow or made of a resilient material or a hard material without resiliency.

The stress roller 10 is not limited to only a first and second object 12 and 14, but can also include additional objects within the shell 16. The shell 16 can completely enclose the objects 12 and 14 within the shell 16.

When the stress roller 10 is used with spherical or cylindrically shaped balls for the objects 12 and 14, then the curvature of the objects accommodates for example the curvature on the back. The objects 12 and 14 can move around within the shell 16 and the objects 12 and 14 around each other in a free motion within the shell 16. The objects 12 and 14 can move independently of each other within the confines of the shell 16. The stress roller 10 can have a certain hardness to provide support for the user. For example, the objects 12 and 14 can be made of a solid, hard material that is not resilient. The solid balls can be made of a solid material such as steel or other type of metal or wood.

The objects 12 and 14 can be also made of a hollow resilient material such a tennis ball for example, or a ball filled with a gas such as air or simply is a hollow vacuum. The objects 12 and 14 can be made of a rubber type material with a certain stiffness to provide support, but still provide a little resiliency. The shell 16 can be stitched around the objects 12 and 14 to provide an enclosure for the objects 12 and 14. The objects 12 and 14 can be balls made of a rubber type material with a certain hardness and resiliency to provide support for the user when placed in for example between a hard surface and the user. The resiliency and stiffness of the balls for the objects can be of degree around that of a tennis ball for example.

The shell 16 can be contoured around the objects 12 and 14 as seen in FIG. 1. For example, the shell can form a pinched area between the objects 12 and 14. The shell 16 can be tightly formed around the objects 12 and 14, such as balls.

The shell 16 can also be made of other type of materials such as certain synthetic nylons and cottons or other type of materials. A form fitting type material can be used for the shell, or multiple types of materials can also be used. The movement of the objects 12 and 14 can be constricted to a certain degree by the shell 16 which surrounds the objects 12 and 14. For example, the objects 12 and 14 can be constricted where the objects 12 and 14 are always touching each other, or have a certain amount of gap or movement between each other and within the shell. The tightness of shell 16 constricting the objects 12 and 14 can allow or restrict the movement of the objects 12 and 14. Further, the friction between the objects 12 and 14, and between the objects 12 and 14 and the shell 12 can form the range of motion of the objects 12 and 14 within the shell 16.

The range of motion of the objects 12 and 14 can be, for example, limited to a few degrees between each object 12 and 14 or greater than a few degrees. The objects 12 and 14 are constrained to a predetermined degree and have a certain degree of movement within the shell 16. The shell provides a certain resiliency for the objects 12 and 14, to accommodate cushioning and to apply and receive a certain pressure upon the surface upon which the stress roller 10 is in contact. For example, when a user places his or her back on the stress roller 10 while the stress roller 10 is on the floor, a certain force is given to the back.

The objects 12 and 14 can also be changed to a more solid material in order to provide a different type of force. The stress roller 10 can be adjustable in the type of force or tension it applies or relieves. The resiliency on the objects 12 and 14 can be modified and the resiliency on the shell 16 can also be modified to accommodate the user or the use.

The objects 12 and 14 can be restricted where they touch each other and are tightly enclosed by the shell 16, where the movement is limited to a certain range. The objects 12 and 14 can be a ball made of a certain rubber material. For example, the ball can be composed of two strips of two different or same type of rubber, which a canvas or cloth wrapping. The ball can be hollow and spherical. For a different applied tension upon the user, the ball can also be made of a more solid or less resilient material. The balls can also be made of only a rubber or rubber like material. The balls can also include a material in the inner core being harder than the material surrounding the core and vice versa.

The objects 12 and 14 can roll with respect to each other within the shell 16. The rolling motion, for example when the objects 12 and 14 are balls, provides the certain motion. The rolling action between the balls can be limited by the constriction of the shell 16. The balls within the shell 16 also provide the rolling motion with the surface of the user and the floor, for example.

Referring to FIG. 2, the stress roller 10 can be placed in a bag 20 for easy carrying of the stress roller 10. The bag 20 can include a draw-string 22 for enclosing the stress roller 10 within the bag 20. The bag 20 can be made of the same material as the stress roller 10, such as NEOPRENE. Other type of resilient materials can also be used.

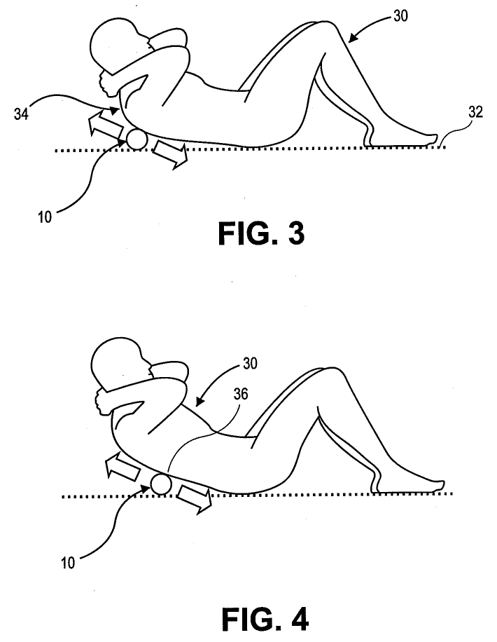

Referring to FIG. 3, the stress roller 10 can be used between the shoulder blades 34 of a user 30. The stress roller 10 can provide relief for the area most affected by excessive stress or activity such as driving, sitting, standing, computer usage, sports, backpacking, or any other activity or stress that can cause a user 30 to slouch forward, causing for example, tightness to the upper back. The tightness to the upper back may cause other injuries if it is not relieved.

The stress roller can be placed on a flat surface 32. The body weight of the user 30 can be used to provide pressure to a particular area of the body of the user 30. The stress roller 10 can be in the middle of the user's 30 back, just below the shoulder blades. Two objects 12 and 14, such as balls, in the stress roller 10, can be evenly lining up on either side of the user's 30 spine.

The user 30 can apply direct pressure on trigger point areas, which would be the muscle area the user 30 feels the discomfort. The user can hold in one spot for approximately 10 to 15 seconds. Then, the user can begin moving muscles back and forth while allowing the stress roller to move with the user. The process can be repeated a certain amount times, for example 5 times. The user can start with gentle pressure and gradually increase to encourage muscle release and help alleviate the stress and pain at the particular area.

While performing this action, the user can take controlled and relaxed breaths in through the nose and out through the mouth. The user can take a certain time and not force the muscle tissue to release. The user can rest then for a certain period of time, for example 30 seconds and repeat a certain amount of times per area, for example 5 times per area.

The activity can be repeated a certain amount of sets per day, for example about 3 sets per day. The above actions can be repeated certain days, including for example every other day for a certain period, for example 2 weeks. Then after, the certain period of time of consistent use, then the stress roller 10 can be used on an as-needed basis. The trigger points can break up depending on the severity within 6 to 8 treatments. The arrows in FIG. 3 show an example range of motion of the rolling of the stress roller 10.

Referring to FIG. 4, the user 30 can use the stress roller 10 around the mid-back area 36 to relieve pain and stiffness in such areas. The stress roller 10 can be used to move or be moved in cooperation with the user's movement, thus providing a wider surface area upon which the force is applied on the back as seen through the arrows of movement.

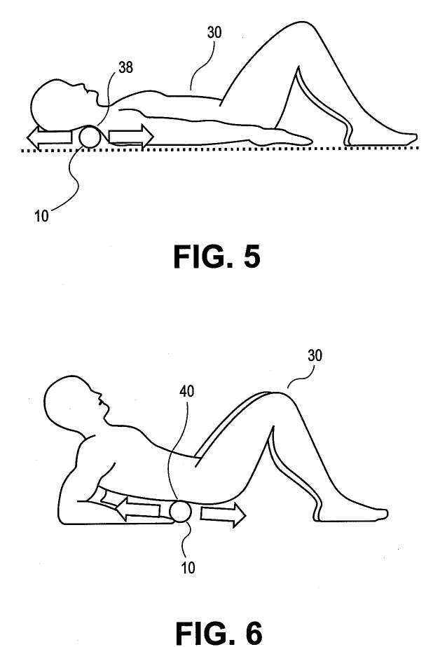

As seen in FIG. 5, the user can place the stress roller 10 in the neck area 38 of the user to relieve pain and stiffness in the neck 38. The range of motion of the stress roller 10 with the user is shown by the arrows. The particular shape of the stress roller 10 provides easy access to the contours of the body including areas of the neck.

Referring to FIG. 6, the user can position the stress roller 10 in the lower back area 10 to relieve the lower back pain and stiffness. The stress roller 10 can be applied in a controlled fashion and with movement, thus allowing application and relief of stress on the particular parts or area of the user. The stress roller 10 allows for a very pinpoint control upon which the force can be applied.

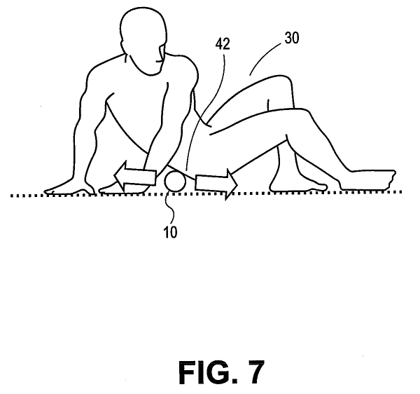

Referring to FIG. 7, the user 30 can position the stress roller 10 in the hip area to relieve hip pain and help piriformis syndrome. The arrows show the motion that can be applied on the stress roller to allow a greater area to be in contact. Additionally, the rolling motion accommodates a certain applied force.

The objects 12 and 14 and shell 16 can be a smooth surface to provide a certain force upon a user and to accommodate the ease of motion. The objects 12 and 14 and the shell 16 can additionally have certain contoured or protruding surfaces to allow for a greater variety of force applied and texture felt by the user through the varying force. For example, the protrusions or rougher surface can provide for a different texture felt by the user.

Additionally, the objects 12 and 14 can also have a heating device or can he heated through an external device in order to apply a different temperature. The shell 16 can also be capable of having certain lotions or liquids applied to it in order to transfer the lotions or liquids to the user when applied to the user's surface area.

The objects 12 and 14 can be a certain size and material to provide the contact area upon the user as needed. The size of the shell 16 is also predetermined to control the amount of movement allowed in the rolling motion of the objects 12 and 14. The objects can also alternatively not be spherical, but be a non-symmetric or blocked surface in order to constrain or control further the movement of the ball when applied to the user.

The shell 16 size including length and width is configured according the objects 12 and 14 it holds in order to allow certain controlled motion. For example, the size of the shell can be controlled to allow for the objects 12 and 14 to move, but always be in contact or be close to contact with each other, thus allowing the proper interaction between the objects 12 and 14. The resiliency of the objects 12 and 14 and the shell 16 provide the flexibility in the control of the stress roller and the proper force to be applied and upon the area needed.

The shell 16 can also contain more than two objects, and can include a plurality of objects, all being constrained and controlled where they are adjacent to each other and have continuous motion and interaction with each other. The shell 16 can also control the objects 12 and 14 to where they are substantially limited in their motion within the shell 16, to where the objects can be substantially stationary within the shell 16, unless a certain force is applied. The rolling motion would then be of the stress roller itself. The stress roller 10 can also be configured to where there is more flexibility in the motion of the objects 12 and 14 within the stress roller 10.

The present invention of the stress roller 10 can also be used for certain exercises in addition to reduction of the stress. The control that is provided by the stress roller 10 allows for a greater variety of applications and the control of the applied area of force allows for a directed contact and application of the stress roller 10.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus, comprising:
a first object;
a second object; and
a shell enclosing the first and second objects controlling the independent movement of the first object and the second object.

2. The apparatus of claim 1, wherein the first object and the second object are balls within the shell accommodating the rolling of the apparatus between first and second surfaces, and accommodating the independent movement between the first and second objects within the shell.

3. The apparatus of claim 2, wherein the balls include a resilient material and shell includes a resilient material.

4. The apparatus of claim 1, wherein the shell includes a polychloroprene material.

5. The apparatus of claim 1, wherein each one of the objects include two similar strips of rubber forming a hollow spherical shape and covered by a synthetic or natural cloth.

6. The apparatus of claim 1, wherein the shell provides a resilient hollow space for movement of the first and second object while the first and second objects touch at least an area without being connected.

7. The apparatus of claim 1, wherein the shell being stretched by the outer circumferences of the first and second objects and tapering in the space between the first and second objects.

8. A method of manufacture, comprising:
forming a first object of a resilient material;
forming a second object of a resilient material; and
enclosing the first and second objects and accommodating movement of the first object and the second object controlled according to the material, shape and dimensions of the first and second objects in relation to the shape, dimensions and material of the shell.

9. The method of claim 8, wherein the first object and the second object are balls within the shell accommodating the rolling of the apparatus between first and second surfaces independently.

10. The method of claim 9, wherein the balls include a resilient material and shell includes a resilient material.

11. The method of claim 8, wherein the shell includes a polychloroprene material.

12. The method of claim 8, wherein each one of the objects include two similar strips of rubber forming a hollow spherical shape and covered by canvas.

13. The apparatus of claim 8, wherein the shell provides a resilient hollow space for movement of the first and second object while the first and second objects touch at least an area without being connected.

14. The apparatus of claim 8, wherein the shell is stretched by the outer circumferences of the first and second objects and tapering in the space between the first and second objects.

15. A rolling apparatus, comprising:
a first means for rolling;
a second means for rolling; and
a means for enclosing completely the first and second means for rolling and accommodating a certain movement of the first object and the second object constrained according to certain predetermined conditions.

16. The apparatus of claim 15, wherein the first means for rolling and the second means for rolling are spheres within the shell accommodating the rolling of the apparatus between an external first surface and an external second surface.

17. The apparatus of claim 16, wherein the spheres include a resilient material and enclosing means includes a resilient material.

18. The apparatus of claim 15, wherein the enclosing means includes a polychloroprene material.

19. The apparatus of claim 15, wherein each one of the objects include two similar strips of rubber forming a hollow spherical shape and covered by canvas.

20. The apparatus of claim 15, wherein:
the enclosing means provides a resilient hollow space for movement of the first and second rolling means while the first and second rolling means touch at least an area without being connected, and
the enclosing means being stretched by the outer circumferences of the first and second rolling means and tapering in the space between the first and second rolling means, and the rolling means within the shell are controlled in their movement according to the size of the enclosing means encapsulating the objects.
